(19) United States
(12) Patent Application Publication
(10) Pub. No.: US 2017/0008003 A1
(43) Pub. Date: Jan. 12, 2017

(54) APPARATUS AND PROCESS FOR WET CRUSHING MINED OIL SAND

(71) Applicant: SYNCRUDE CANADA LTD. in trust for the owners of Syncrude Project as such owners exist now and in t, Fort McMurray (CA)

(72) Inventors: RON CLEMINSON, Fort McMurray (CA); MICHAEL CARNIATO, Calgary (CA)

(21) Appl. No.: 15/188,741

(22) Filed: Jun. 21, 2016

Related U.S. Application Data
(60) Provisional application No. 62/189,591, filed on Jul. 7, 2015.

(51) Int. Cl. B02C 4/04; B01F 15/02; B02C 23/38; B01F 3/12; B02C 4/08; B02C 4/28

(52) U.S. Cl. CPC B02C 4/04; B02C 4/08; B02C 4/286; B02C 23/38; B01F 3/1271; B01F 3/1214; B01F 15/0229; B01F 2003/1285; B01F 2003/1257; B01F 2215/008; B01F 2215/0081; B01F 2215/0083

(57) ABSTRACT

A slurry preparation tower is provided comprising an intake opening through which oil sand enters the slurry preparation tower; a first sizer device operative to comminute oil sand passing through the first sizer device to a first upper size threshold; a second sizer device operative to comminute oil sand passing through the second sizer device to a second upper size threshold, wherein the second upper size threshold is less than the first upper size threshold; a first solvent supply device for adding solvent to the oil sand prior to or during its comminution in the first sizer device; and a plurality of deflector plates positioned between the first sizer device and the second sizer device to assist in the mixing of the first comminuted oil sand and solvent.

### FIELD OF THE INVENTION

The present invention relates to an apparatus and process for wet crushing mined oil sand to form a pumpable and pipelinable oil sand slurry without screening.

### BACKGROUND OF THE INVENTION

Oil sand containing bitumen mined from the ground is generally slurried with a solvent such as water as part of an initial process for eventually removing the bitumen from the oil sand. Oil sand is a type of bitumen deposit typically containing sand, water and very viscous oil (the bitumen). When the oil sand deposit is located relatively close below the ground surface, the oil sand is often extracted from the deposit by mining. The oil sand is mined by excavating down through the ground surface to where the oil sand deposit occurs and removing oil sand from the deposit with heavy machinery.

Typically, this removal of the oil sand from the deposit is done with some of the largest power shovels and dump trucks in the work, with the power shovels removing shovel-loads of oil sand from the deposit and loading the collected oil sand onto conveyors to be carried away for further processing.

The viscous bitumen tends to hold the sand and water together causing the mined oil sand to contain lumps and chunks, some of which can be quite large. Because of the size of some of these pieces of mined oil sand, the mined oil sand is typically “pre-crushed” by running it through a preliminary crusher (often referred to as a “primary crusher”) to crush the pieces of oil sand to a suitable size for transport on a conveyor (i.e. conveyable size).

The pre-crushed oil sand is then transported by conveyor to a slurry preparation unit as known in the art where the pre-crushed oil sand is further processed to form an oil sand and water slurry.

The slurry preparation unit has to ensure that the pieces of oil sand in the oil sand and water slurry are of pumpable size before the slurry is directed to a pump box and pump to be pumped to the next step in its processing, for example, hydrotransporting the slurry in a pipeline for further conditioning. Therefore, oversize pieces of oil sand or other materials have to be prevented from being directed to the pump in order to obtain a pumpable, pipelinable oil sand slurry. There are at least two forms of slurry preparation units that have been used to form the oil sand and water slurry; slurry preparation units that use screening and more recent screen-less slurry preparation units.

Slurry preparation units that use screening typically comprise a vertically stacked series of components. The pre-crushed oil sand is initially fed into a mixing box where water is mixed with the oil sand to form the slurry. From the mixing box, the oil sand and water slurry is passed through some sort of screening device to remove oversize from the oil sand and water slurry. The slurry that passes through the screening device passes into a pump box where it is pumped to the next stage of the process. The rejected oversize that does not pass through the screening device is rerouted to a crusher to be comminuted and then added to a secondary mix box and again mixed with water to form a slurry before this slurry is passed through another screening device. The portion of the slurry that passes through this other screening device is then returned to the main slurry components. The oversize rejects that do not pass through the second screening device are treated as rejects and removed from the system. The removed rejects are typically eventually hauled away by trucks and dumped in a discard area.

Slurry preparation units that use screens have a disadvantage in that a portion of the oil sand passing through the slurry preparation units is rejected by the system. This rejection of a portion of the oil sand means that the bitumen in this rejected oil sand is lost, as it is not extracted at later process stages like the rest of the system. In some screening processes, the rejection rate can be as high as 8%. This rejection rate can add up to a significant amount of bitumen that is simply being thrown away. More recently, screen-less slurry preparation towers have been used such as the screen-less system described in U.S. Pat. No. 7,431,830 and Canadian Patent No. 2,480,122.

Screen-less slurry preparation towers form all of the oil sand and other materials entering the slurry preparation tower into a slurry and as such avoid rejects. In particular, essentially all of the oil sand that enters the tower is typically comminuted in one or more stages to a pumpable size while water is being added to it to form a slurry. This allows bitumen to be extracted from essentially all of the oil sand delivered to the slurry preparation tower, thereby essentially eliminating rejects.

However, the screen-less slurry preparation tower must be designed such that proper and sufficient mixing of crushed oil sand and water occurs to form pumpable oil sand slurry. Thus, there is a need for improved mixing in screen-less slurry preparation towers.

### SUMMARY OF THE INVENTION

In an aspect, a slurry preparation tower is provided comprising in series an intake opening through which oil sand enters the slurry preparation tower; a first sizer device operative to comminute oil sand passing through the first sizer device to a first upper size threshold; a second sizer device operative to comminute oil sand passing through the second sizer device to a second upper size threshold, wherein the second upper size threshold is less than the first upper size threshold; a first solvent supply device for adding solvent to the oil sand prior to or during its comminution in the first sizer device; and a plurality of deflector plates positioned between the first sizer device and the second sizer device to assist in the mixing of the first comminuted oil sand and solvent.

In one embodiment, the plurality of deflector plates positioned between the first sizer device and the second sizer device includes at least one convex deflector plate and at least one concave deflector plates. It is understood, however, that the deflector plates can be uniplanar as well.

In one embodiment, a second solvent supply device is provided between the first sizer device and the second sizer device to further dilute the oil sand and solvent mixture. In one embodiment, the solvent is water.

In another embodiment, at least one deflector plate is also positioned between the intake opening and the first sizer device. In one embodiment, the at least one deflector plate is positioned above the first water supply device and is convex for dividing the oil sand feed into two streams. In another embodiment, the at least one deflector plate positioned between the intake opening and the first sizer device is positioned below the first solvent supply device.

In another aspect, a method of forming a pumpable oil sand slurry is provided comprising the steps of providing at least one conveyor for delivering the mined oil sand to a slurry preparation tower, the slurry preparation tower having a first sizer and a second sizer; adding a solvent to the oil sand prior to comminuting the oil sand in the first sizer to a first upper size threshold; mixing the comminuted oil sand and solvent that has passed through the first sizer by means of a plurality of deflector plates prior to comminuting the oil sand and solvent mixture in the second sizer to a second upper size threshold that is less than the first upper size threshold to produce the pumpable oil sand slurry.

In one embodiment, the pumpable oil sand slurry exits the slurry preparation tower into a pump box.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a schematic illustration of an open side view of a slurry preparation tower of the present invention and process for forming a pumpable oil sand slurry.

FIG. 2A is an open front view of a slurry preparation tower of the present invention having a serrated deflector plate at its open top.

FIG. 2B is a top view of the serrated deflector plate of FIG. 2A.

### DESCRIPTION OF VARIOUS EMBODIMENTS

The detailed description set forth below in connection with the appended drawings is intended as a description of various embodiments of the present invention and is not intended to represent the only embodiments contemplated by the inventors. The detailed description includes specific details for the purpose of providing a comprehensive understanding of the present invention. However, it will be apparent to those skilled in the art that the present inventions may be practiced without these specific details.

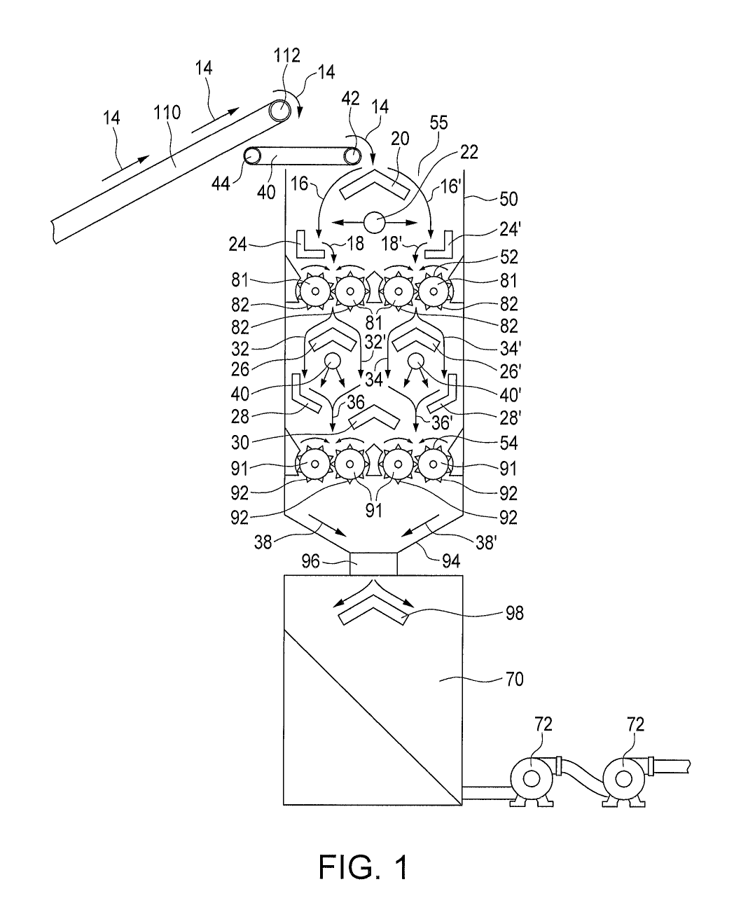

FIG. 1 is a schematic illustration of a slurry preparation tower 50 used to form an oil sand slurry ready for hydrotransport (pumpable oil sand slurry). Oil sand ore mined from an oil sand deposit is routinely first sized in a preliminary (or primary) crusher that reduces the size of the mined oil sand ore to pieces of conveyable size (pre-crushed oil sand ore). For example, pre-crushed oil sand ore may have an average size of 600 mm. Pre-crushed oil sand ore 14 is fed to a conveyor 110 where the pre-crushed oil sand ore 14 is transported along the conveyor 110 to a discharge end 112 of the conveyor 110. At the discharge end 112 of the transport conveyor 110, the pre-crushed oil sand ore 14 drops onto an apron feeder 40 positioned below the discharge end 112 of the conveyor 110, with a first end 42 of the apron feeder 40 positioned over an intake opening 55 in the slurry preparation tower 50.

The slurry preparation tower 50 has two comminuting stages implement with a first sizer 52 and a second sizer 54. In one aspect, the first sizer 52 can include four (4) rotatable elements in the form of crusher rolls 81 having a generally cylindrical shape and positioned side-by-side, however, it is understood that any type of mineral sizer that is know in the art could be used for the first sizer 52. Each of the crusher rolls 81 have a plurality of crusher teeth 82 to aid in comminuting the larger pieces of pre-crushed oil sand ore 14. The crusher rolls 81 are spaced a set horizontal distance apart to form gaps between adjacent crusher rolls 81. The size of the gaps determines the first upper size threshold the secondary sizer 52 will size oil sand passing through the first sizer 52. As shown in FIG. 1, the four crusher rolls 81 comprise two pairs of oppositely rotating crusher rolls.

The pre-crushed oil sand 14 drops off the first end 42 of the apron feeder 40 and onto a deflector plate 20, which may be convex in shape and thus splits the oil sand feed into two feed streams 16, 16′. Deflector plate 20 is located at or near intake opening 55 of slurry preparation tower 50. Solvent supply device 22 is positioned below deflector plate 20 and is operative to spay a solvent such as water onto both feed streams 16, 16′.

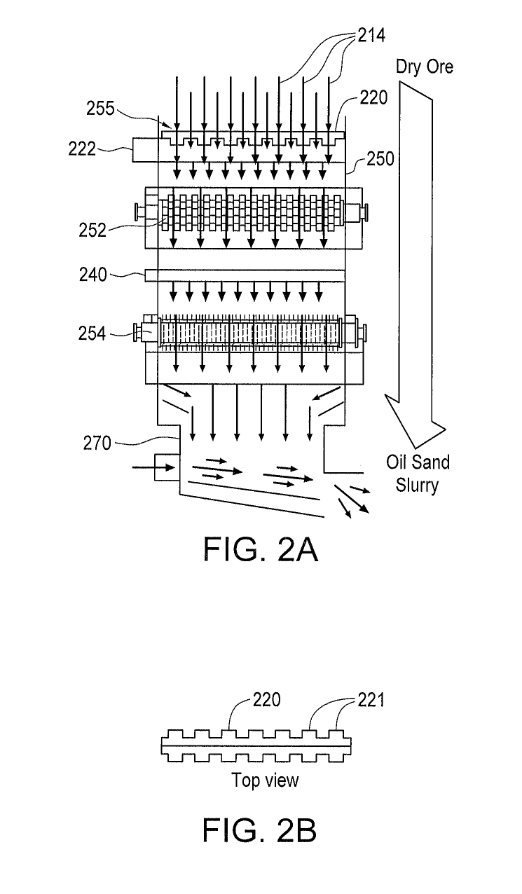

In one embodiment, as shown in FIG. 2A and FIG. 2B, slurry preparation tower 250 may comprise first sizer 252, second sizer 254, and a serrated deflector plate 220 (also referred to as a serrated impact beam) located at or near intake opening 255 of the tower. The serrated deflector plate 220 presents to the incoming pre-crushed oil sand ore 214 an irregular surface due to projections 221 to assist in the fragmentation of the ore, thereby increasing the wettability of the ore when it is sprayed with a solvent (e.g., process water) from solvent supply device 222. Thus, there is good exposure of the pre-crushed oil sand ore 214 to the solvent due to the increase in surface area of the ore. The serrated deflector plate 220 may also prevent build up of oil sand thereon. Finally, the serrated deflector plate 220 may provide protection to the solvent supply device 222, which is positioned immediately below. The slurry preparation tower 250 may further comprise a second solvent supply device 240. The oil sand slurry is then collected in a recycle mix box 270, wherein a 1:1 ratio of fresh oil sand slurry and recycled oil sand slurry is pumped to a hydrotransport pipeline (not shown).

The wetted oil sand ore then falls on deflector plates 24, 24′, which are positioned below the solvent supply device 22. Deflector plates 24, 24′ may be concave in shape in order to direct feed streams 16, 16′ into two feed streams 18, 18′ such that each feed stream drops in between the each pair of crusher rolls, respectively. It is understood, however, that deflector plates 24, 24′ can also be uniplanar.

The first sizer 52 comminutes the oil sand passing through the first sizer 52 to a first upper threshold size so that substantially all the pieces of oil sand that have passed through the first sizer 52 are no greater in size than the first upper threshold size. In one aspect, this first upper threshold size is approximately eight (8) inches so that substantially all of the pieces of oil sand that have passed through the secondary sizer 52 are eight (8) inches in size or less.

The second sizer 54 comminutes the oil sand passing through the second sizer 54 to a second upper threshold size. The second upper threshold size is smaller than the first upper threshold size. In this manner, the second sizer 54 reduces the size of the larger pieces of oil sand even more than the first sizer 52. In one aspect, this second upper threshold size is approximately four (4) inches so that substantially all of the pieces of oil sand that have passed through the second sizer 52 are four (4) inches in size or less.

In one aspect, the second sizer 54 can include four (4) rotatable elements in the form of crusher rolls 91 positioned side-by-side, however, as previously mentioned, any type of mineral sizer known in the art could be used for the second sizer 54. Each of the crusher rolls 91 have a plurality of crusher teeth 92 to aid in comminuting pieces of oil sand ore still present. However, the gaps between adjacent crusher rolls 91 are smaller than the gaps between adjacent crusher rolls 81 of the first sizer 52, so that the second sizer 54 comminutes material to a smaller size than the first sizer 54. Additionally, the crusher teeth 92 on the crusher rolls 91 may be smaller and there may be more crusher teeth 92 on a crusher roll 91 than the number of crusher teeth 82 on the crusher rolls 81 of the first sizer 52. As shown in FIG. 1, the four crusher rolls 91 comprise two pairs of oppositely rotating crusher rolls.

Directly below the first pair of crusher rolls of the first sizer 52 is a deflector plate 26 and directly below the second pair of crusher rolls of the first sizer 52 is a deflector plate 26′. Deflector plate 26 may be convex in shape to split the oil sand and solvent from the first pair of crusher rolls into two feed streams 32, 32′. Feed streams 32, 32′ are further mixed by means of deflector plate 28 and deflector plate 30. Optionally, additional solvent such as water can be added to streams 32, 32′ by means of solvent supply device 40. The mixed oil sand and solvent stream 36 now drops in between the first pair of crusher rolls of the second sizer 54. Similarly, deflector plate 26′ may be convex in shape to split the oil sand and solvent from the second pair of crusher rolls of the first sizer 52 into two feed streams 34, 34′. Feed streams 34, 34′ are further mixed by means of deflector plate 28′ and deflector plate 30. Optionally, additional solvent such as water can be added to streams 34, 34′ by means of solvent supply device 40′. The mixed oil sand and solvent stream 36′ now drops in between the second pair of crusher rolls of the second sizer 54.

A pump box 70 is provided below the second sizer 54 so that oil sand slurry streams 38, 38′ that have passed through the second sizer 54 can drop into the pump box 70 and the oil sand slurry can be pumped by one or more pumps 72 to the next stage in the process. In one embodiment, the bottom of slurry preparation tower 50 is cone shaped, directing streams 38, 38′ to outlet 96, which outlet may be connected to pump box 70. In one embodiment, pump box 70 comprises a deflector plate 98 positioned beneath outlet 96 to further mix the oil sand slurry prior to pumping.

In operation, oil sand ore is discharged from the discharge end 112 of the conveyor 110 and onto the apron feeder 40. In normal operation, the apron feeder 40 discharges the oil sand from the first end 42 of the apron feeder 40 through the intake opening 55 and drops it downwards towards the first sizer 52. As the oil sand ore falls towards the first sizer 52, a solvent, such as water, can be sprayed onto the falling oils sand ore using the first solvent supply device 22, wetting the falling oil sand ore that contacts the first sizer 52.

When the oil sand ore reaches the first sizer 52, the oil sand ore is comminuted as it passes through the first sizer 52 to a size equal to or smaller than the first upper size threshold before the oil sand exits the first sizer 52 and drops towards the second sizer 54.

Oil sand that has passed through the first sizer 52 falls downwards towards a plurality of deflector plates positioned between the first sizer 52 and the second sizer 54. The deflector plates aid in mixing the oil sand and water that exits from first sizer 52. Optionally, additional solvent, such as water, can be sprayed onto the falling oil sand and solvent from first sizer 52 using at least one second solvent supply device 40, 40′, thereby wetting the falling oil sand and solvent further. Further mixing occurs as the oil sand and solvent contact the deflector plates prior to passing through the second sizer 54.

The second sizer 54 comminutes the oil sand to a size equal to or smaller than the second upper size threshold before allowing the oil sand to pass through the second sizer 54.

Oil sand and solvent that has passed through the second sizer 54 drops into the pump box 70 positioned below the second sizer 54 where the oil sand and water slurry will be pumped by the one or more pumps 72 to the next stage of the bitumen extraction process for further processing.

In this manner, substantially all of the oil sand ore that is introduced into the slurry preparation tower 50 through the intake opening 55 exits the slurry preparation tower as an oil sand and water slurry to be transported to the next stage in its processing. All of the oil sand ore in the slurry has been reduced to a pumpable size and none of the oil sand ore is rejected from the slurry preparation tower to be hauled away and discarded.

The present invention makes good use of the elevation of the slurry preparation tower by integrating deflector plates which aid in the formation of pumpable oil sand slurry. Thus, the present invention provides a more vertically efficient layout without compromising mixing of oil sand slurry. Hence, by providing deflector plates on the walls of the slurry preparation tower between the first sizer 52 and second sizer 54 and/or below the roll gaps of the first sizer 52, the flow is directed in an optimized manner to further stimulate slurry formation. It is understood, however, that other configurations of deflector plates in the space between the first sizer 52 and second sizer 54 can be used. Deflector plates can be any variety of shapes, for example, concave, convex, uniplanar, etc.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A slurry preparation tower, comprising:
an intake opening through which oil sand enters the slurry preparation tower;
a first sizer device operative to comminute oil sand passing through the first sizer to a first upper size threshold;
a second sizer device operative to comminute oil sand passing through the second sizer device to a second upper size threshold, wherein the second upper size threshold is less than the first upper size threshold;
a first solvent supply device for adding solvent to the oil sand prior to or during its comminution in the first sizer device; and
a plurality of deflector plates positioned between the first sizer device and the second sizer device to assist in the mixing of the first comminuted oil sand and solvent.

2. The slurry preparation tower as claimed in claim 1, wherein the plurality of deflector plates positioned between the first sizer device and the second sizer device comprises at least one convex deflector plate, at least one concave deflector plate, at least one uniplanar deflector plate, or a combination thereof.

3. The slurry preparation tower as claimed in claim 1, further comprising a second solvent supply device located between the first sizer device and the second sizer device to further dilute the oil sand and solvent mixture.

4. The slurry preparation tower as claimed in claim 1, wherein the solvent is water.

5. The slurry preparation tower as claimed in claim 1, further comprising at least one deflector plate positioned between the intake opening and the first sizer device.

6. The slurry preparation tower as claimed in claim 5, where the at least one deflector plate positioned between the intake opening and the first sizer device is convex in shape and is positioned above the first water supply device for dividing the oil sand feed into two streams.

7. The slurry preparation tower as claimed in claim 6, wherein the at least one deflector plate positioned above the first water supply device is serrated.

8. The slurry preparation tower as claimed in claim 5, wherein the at least one deflector plate positioned between the intake opening and the first sizer device is concave in shape and is positioned below the first water supply device for directing the oil sand and solvent to the first sizer device.

9. The slurry preparation tower as claimed in claim 1, wherein the first sizer device comprises a plurality of horizontally space-apart rotating elements.

10. The slurry preparation tower as claimed in claim 9, wherein each rotating element has a plurality of crusher teeth provided on an outer surface of the rotating elements.

11. The slurry preparation tower as claimed in claim 1, wherein the second sizer device is positioned directly below the first sizer device so that substantially all of the oil sand that has passed through the first sizer device drops onto the second sizer device.

12. The slurry preparation tower as claimed in claim 1, wherein both the first sizer device and the second sizer device comprise a plurality of horizontally space-apart rotating elements.

13. The slurry preparation tower as claimed in claim 12, wherein each rotating element has a plurality of crusher teeth provided on an outer surface of the rotating elements.

14. A method of forming a pumpable oil sand slurry, comprising:
providing at least one conveyor for delivering the mined oil sand to a slurry preparation tower, the slurry preparation tower having a first sizer and a second sizer;
adding a solvent to the oil sand prior to or during comminuting the oil sand in the first sizer to a first upper size threshold;
mixing the comminuted oil sand and solvent that has passed through the first sizer using a plurality of deflector plates prior to comminuting the oil sand and solvent mixture in the second sizer to a second upper size threshold that is less than the first upper size threshold to produce the pumpable oil sand slurry.

15. A system for preparing a pumpable oil sand slurry, comprising:
a slurry preparation tower as claimed in claim 1;
at least one conveyor, having a discharge end, for transporting mined oil sand to the intake opening of the slurry preparation tower; and
a pump box for receiving oil sand and solvent that has passed through the second sizer and feeding it to a pump.

16. The system of claim 15, further comprising a preliminary crusher for crushing mined oil sand to reduce the size of mined oil sand prior to its entry into the slurry preparation tower.
